(19) United States
(12) Patent Application Publication
(10) Pub. No.: US 2006/0029460 A1
(43) Pub. Date: Feb. 9, 2006

(54) Writing instrument adapter

(76) Inventor: Carmine Joseph Russo, Farmingville, NY (US)

Correspondence Address: KLAUBER & JACKSON, 411 HACKENSACK AVENUE, HACKENSACK, NJ, 07601, US

(21) Appl. No.: 11/198,928

(22) Filed: Aug. 5, 2005

Related U.S. Application Data
(60) Provisional application No. 60/599,396, filed on Aug. 6, 2004.

(51) Int. Cl. B43K 23/12; B43K 23/00

(52) U.S. Cl. 401/247; 401/98

(57) ABSTRACT

A writing instrument adapter comprises a tubular housing having a first end adapted to releasably hold a writing instrument such as a pencil, and a second end that provides a cap function and that in one embodiment, is adapted to hold an eraser. The adapter defines air passage means within the housing so that breathing may continue and suffocation may be averted in the instance where the instrument is accidentally lodged in the mouth or throat of a user.

### CROSS REFERENCE TO RELATED APPLICATION

The present application claims the priority of co-pending provisional application U.S. Ser. No. 60/599,396, filed on Aug. 6, 2004, and the disclosure of this application is incorporated by reference herein its entirety. Applicants claim the benefits of this application under 35 U.S.C. §119(e).

### FIELD OF THE INVENTION

The present invention relates generally to writing instruments, such as pens, pencils and the like and particularly to devices that may be reused together with consumable writing instruments, including pencils, pens and the like. More particularly, the invention concerns an adapter for use with pencils that provides and extension thereof and can likewise serve as a container, shroud or cap for the same when the writing instrument is not in use.

### DESCRIPTION OF THE ART

In general, writing instruments including both pens and pencils, have been in existence for many years in a variety of shapes and with an equally diverse array of constructions and features. Thus, pencils which rely upon a solid marking material such as a graphite or the like, lead, as well as colored materials of like composition, have been known in both the basic integral and consumable construction of a standard wood and shrouded pencil, as well as in the form of refillable mechanical pencil devices. Likewise, pens have evolved from the earliest construction constituting a feather or quill, to complex constructions where a consumable liquid ink is contained in a refillable reservoir within the pen body and, upon use, the ink is fed to a channel disposed adjacent the writing point.

Both instruments have evolved from their origins where they were maintained at a desk or other writing surface, to more portable environments, i.e. where they are carried on the person of the user. In the instance of the pen, which utilizes a supply of liquid ink, the pen's structure includes a removable cap which is placed over the writing end of the pen when it is not in use and is being transported on the person of the user. In this manner, a cap avoids any accidental damage to the user's garments or other injury to the user as might result by the inadvertent of the exposure of the point and its penetration to the user's body in an accidental movement. Even in this instance, forgetfulness on the part of the user may result in such mishaps, as when the cap is not replaced on the writing end when in transit.

In the case of pencils, and particularly the consumable unitary types that are in longstanding and broad usage, such writing instruments are rarely if at all, sold or provided with cap means. Several circumstances associated with the use of such pencils are noted to exist, that represent disadvantages and in some instances, dangers to their use.

For example, such pencils require periodic sharpening of the writing ends, in as much as repeated use will result in the blunting of the writing point. In the instance of such unitary structures, the sharpening of the pencil is achieved by the use of an instrument which shaves away the writing end to form a fine point. This generally involves the removal of a portion of the pencil structure and the consequent shortening of the length of the pencil. There reaches a stage in the use of such a pencil, where its size is so diminished that it is no longer practical for use by the writer because it is too small. Frequently, this results in the discarding of such foreshortened instruments and the consequent wasting of the materials associated with its manufacture.

A more significant and likewise important limitation on the use of such structures is the fact that a cap structure is generally not used with the instrument. Thus, several circumstances arise all of which are or can lead to undesirable, injurious or indeed, even dangerous consequences. For example, the carrying of the pencil in the shirt pocket or pants pocket of a user with the writing end exposed, risks the damage or discoloration of the clothing of the person on which the instrument is carried, as well as the inherent danger in the event that an inadvertent motion by the person may result in the puncturing of the person's skin and other injury to the person's body by the sharpened pencil point. A further and more dangerous circumstance arises in the instance where pencils of this type are being used by young children, or, likewise, where such pencils are available to such young children. Young children frequently have a tendency to place a lot of objects in their mouths, and this is likewise the case with the pencils. Thus, it is possible that a young child might place such an object in his or her mouth with the potential for injury to the throat of mouth cavity or even suffocation in the instance where the instrument is lodged in such cavity. While it is important to be vigilant and to try and guard against such occurrences developing, such incidents can nonetheless take place.

As the continued presence and use of the standard pencil of the type just described is highly likely to continue, a need exists to provide a product or instrument that can favorably address some of the shortcomings identified above. It is toward the fulfillment and favorable resolution of the mentioned shortcomings that the present invention is directed.

### SUMMARY OF THE INVENTION

In its broadest aspect, the present invention relates to a writing instrument adapter which comprises an essentially tubular housing or barrel, which housing or barrel defines a first writing instrument-receiving opening, a second cap-defining/receiving opening and a continuous inner wall surface that extends therebetween. Gripping means are disposed on the inner wall surface and are located proximate to the first opening for releaseably engaging a writing instrument therein. Ventilation means are located proximate to the said second opening for allowing the passage of air through the adapter to avert or relieve suffocation of a user in the instance where the writing instrument or adapter is accidentally lodged in an air passageway of the user.

In a particular aspect of the invention, the gripping means comprises one or more ribs or rings that extend radially inward from the inner wall surface. In a particular embodiment, the ribs are continuous and define a single sleeve, or for example, a helical strip or a single ring, both of which project inwardly from the inner wall surface. Alternately, the ribs may define two or more rings. In a further aspect, the ribs are resilient and are thereby adapted to deform to accept the outer circumference of the inserted writing instrument. All of the described embodiments of the ribs enable the adapter to receive writing instruments that may vary in outer circumferential shape, so that the outer octagonal shape of a standard pencil as well as variations on that shape, including a circular outer circumference, can all be accommodated and securely engaged within the adapter in use.

The second opening or end of the adapter is provided to receive an end cap or eraser. In one embodiment, the cap may be sized and configured to be placed over the second opening and thereby to telescopically receive the opening and that portion of the barrel of the adapter there within. In an alternative embodiment, the cap in question may be sized so as to be insertable for telescopic reception within the said second opening. In both embodiments, the cap may be a plain cup shaped member which may in a further embodiment, define or have associated therewith an eraser. In a further embodiment of the invention, the cap may be an eraser. In all of the described embodiments, the second opening or end of the adapter may define a plurality of slits that extend axially (and longitudinally) therefrom, and that confer a radial resilience that, for example, may be inwardly biased, to secure the inserted cap or eraser. A stop member may also be defined, to limit the extent of axial insertion of the cap or eraser, and in the instance of the latter, to support it in position for use. In any of the embodiments where an eraser is present, it may be disposed so as to extend outwardly and away from the second opening, in the customary fashion of erasers associated with pencils and like writing instruments.

A further aspect of the adapter of the invention is the inclusion of the ventilation means which is located proximate to the second opening. In a particular embodiment, the ventilation means may comprise at least two through bores or openings that are located along the circumference of the barrel, and spaced apart from the second end but proximal thereto. In a particular embodiment, a plurality of such openings may be located and regularly aspaced about the circumference of the barrel, and in a more particular configuration, may be in alignment with each other along such circumference. In an alternate non-limiting embodiment, and particularly where the axial slits are present, the openings may be disposed in axial alignment with and in like number to the said slits. The provision of the openings in this manner and the consequent construction of the ventilation means, assures that, in the instance where the writing instrument is lodged in the throat or other breathing passage of a user, that air can circulate through the writing instrument and thereby prevent the development of suffocation of the affected user. This feature is particularly pertinent in the instance where the user is a young child and has accidentally lodged the writing instrument or the barrel in such breathing passage.

Accordingly, it is a principal object of the present invention to provide an adapter for writing instruments that have a sharp point and that are thereby likely to render the users prone to damage, inconvenience or danger.

It is a further object of the present invention to provide an adapter as aforesaid that includes the ability in the instance of a consumable eraser to provide the basis for the replacement of an eraser on the writing instrument.

It is a still further object of the present invention to provide an adapter which enables a consumable writing instrument to be mounted within a fixed and extended barrel for increased useful life.

Other objects and advantages will become apparent to those skilled in the art from a review of the ensuing detailed description which proceeds with reference to the following illustrative drawings.

### BRIEF DESCRIPTION OF THE DRAWINGS

FIG. 1 is a front perspective view of an adapter in accordance with one embodiment of the present invention illustrating the outwardly apparent features thereof.

FIG. 2 is a side sectional view of the adapter of FIG. 1, illustrating the gripping means and ventilation means thereof.

FIG. 3 is a side sectional view similar to that of FIG. 2, showing the adapter of the present invention with a writing instrument positioned there within for use.

FIG. 4 is a side sectional view similar to that of FIG. 2, illustrating the adapter of the present invention with a writing instrument positioned for storage with the writing point located within the adapter, and with an eraser disposed on the opposite end thereof.

FIG. 5 is a side sectional view illustrating the adapter of the present invention and defining certain of the dimensions that may be utilized in accordance with a preferred embodiment thereof.

FIG. 6 is a front view showing the first end of the adapter and the ribs extending inwardly from the inner surface thereof.

FIG. 7 is a side sectional view illustrating an alternate embodiment of the adapter of the present invention.

FIG. 8 is a rear perspective view illustrating an adapter of the present invention in accordance with an alternate embodiment thereof.

FIG. 9 is a side view of the adapter of FIG. 8.

FIG. 10 is a sectional view of the adapter of FIG. 9.

FIG. 11 is an end view of the adaptor of FIG. 10.

### DETAILED DESCRIPTION OF THE INVENTION

In accordance with the present invention the foregoing objects and advantages are readily attained.

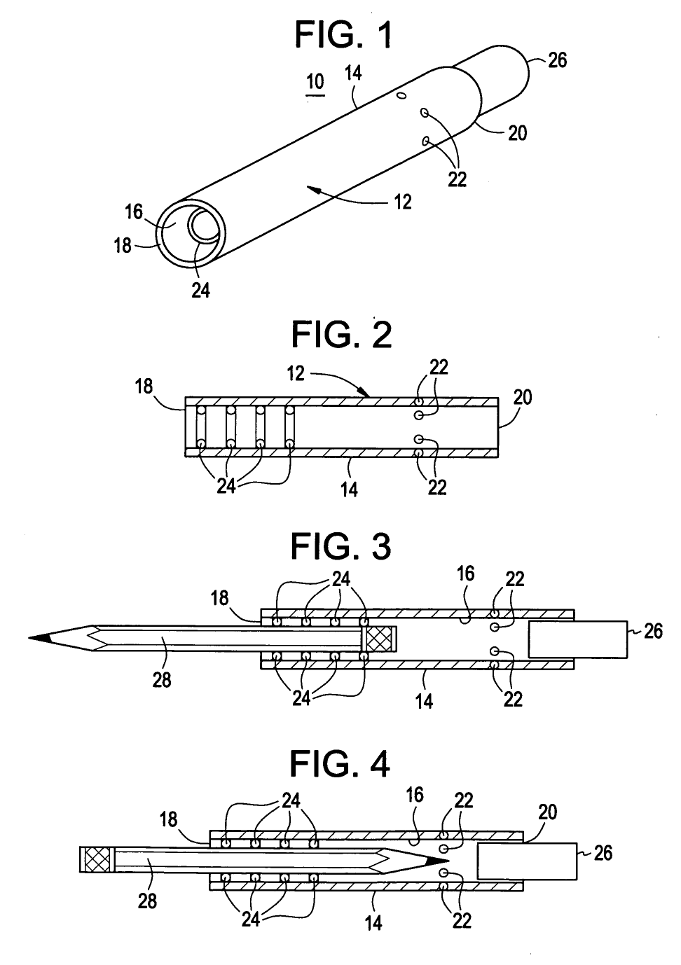

Referring now to the drawings, wherein like numerals denote like parts, and particularly to FIG. 1, a writing instrument adapter is shown, and denominated with the numeral 10, which comprises an essentially tubular housing or barrel generally designated 12. Barrel 12 has an outer surface 14 and a corresponding inner wall surface 16. One end of housing or barrel 12 terminates in a first writing instrument receiving opening 18, and at the opposite end thereof, cap-defining or receiving opening 20 is defined and shown. As illustrated in FIG. 1, cap-defining or receiving opening 20 is adapted to hold an eraser, labelled 26. While eraser 26 is shown and depicted in FIG. 1, it is to be understood that modifications of the adapter 10 may include the disposition of a cap (not shown) that engages barrel 12 at the end proximate to opening 20, and that may either have an inner diameter that is larger than the outer diameter of barrel 12 and thereby that receives the barrel there within, or which has a diameter corresponding to that of eraser 26 and that thereby nests within opening 20. Both embodiments are contemplated within the scope of the present invention as defined, illustrated and claimed.

Referring further to FIG. 1, adapter 10 includes gripping means disposed on inner wall surface 16 and located proximate to opening 18. Referring also to FIG. 2, representative gripping means is shown which comprises one or more ribs labelled 24 that, as illustrated, extend radially inward from inner wall surface 16 and that can in one embodiment, be continuous and thus disposed to releaseably engage a writing instrument such as a pencil, that may be inserted in opening 18 and releaseably held within adapter 10 as illustrated herein. Ribs 24 may also be discrete strips that are intermittently spaced along inner wall surface 16.

In a particular embodiment, and as best illustrated in FIG. 2 herein, ribs 24 may be continuous in nature and may be accordingly a plurality of rings. Moreover, the ribs 24 may be prepared from a resilient material such as an elastomeric polymer or the like, to offer a suitably resilient and adhesive outer surface to securely maintain the writing instrument within the barrel 12. By way of illustration and not limitation, the ribs 24 may be 0.5 millimeter in height (or thickness) and may be displaced 1 centimeter from first end 18. In the instance where four such ribs 24 are defined, they may be regularly spaced so that in total, they occupy 1 centimeter of the axial length of the barrel 12. Naturally, the foregoing is purely illustrative and not restrictive, and the invention is considered to embrace all reasonable variations in such dimensions within its spirit and scope.

Referring now to FIGS. 7, 10 and 11, alternate constructions of gripping means are illustrated. In FIG. 7, the gripping means comprises a sleeve 30 that extends axially along inner wall surface 16 as shown. In an alternate embodiment illustrated in FIG. 10, a helical rib 30 extends along a wall surface 16. All variations of the gripping means of the invention are therefore intended to be embraced and covered herein.

Referring now to FIGS. 8-11, an alternate construction of the cap-receiving end 20 is illustrated. Thus, FIG. 8 shows an adapter 10′ with a cap-receiving end 20′ that has been modified to define a plurality of slits 32 that divide end 20′ into a plurality of gripping fingers 34, also clearly depicted in FIG. 9. Fingers 34 can be inwardly biased, and will thereby assist in frictionally retaining an end cap or eraser that would be inserted therein.

Referring now to FIG. 10, a stop means or stop member 36 is depicted that serves to limit the extent to which an eraser or end cap may be inserted within end 20′. Stop means/stop member 36 is also shown FIG. 11, and can be seen to provide as illustrated, plural prongs or lands 38 that receive the inserted end of the eraser.

Referring again to FIGS. 10 and 11, cap-receiving end 20′ defines an additional feature that assists in frictionally engaging and holding the inserted eraser or end cap. Specifically, the leading edge of end 20′ and particularly, fingers 34, are provided at their inner facing edges thereof with an inwardly directed chamfer or extension 40. This can be seen as a ‘thickened’ edge in FIG. 11 and is also depicted in FIG. 10, and can be appreciated as favorably cooperating with the bias of fingers 34 and lands 38, to securely hold the cap or eraser that may be inserted. It is to be appreciated that these modifications and features are illustrative and not restrictive, of the scope of the adapter of the present invention.

Referring further to the figures and particularly to FIGS. 1 and 2, the adapter can also include ventilation means located proximate to second opening 20. As indicated previously, ventilation means allow passage of air through the adapter 10 and thereby seek to avert the possibility of suffocation or other injury in the instance where inadvertent placement of the adapter in the e.g. mouth of a user results in the lodgment of the adapter in the user's throat or other location where breathing is rendered extremely difficult if not impossible. In such circumstances, the ventilation means which comprise openings 22, permit the passage of air through the adapter and may possibly permit the user in the extreme circumstance, to enjoy the circulation of some air and thereby to avert suffocation or gagging. As illustrated in the figures, the ventilation means may comprise a plurality of openings 22, to a logical maximum that permits the passage of air without adversely affecting the structural integrity of the resulting adapter 10. Thus, for example, as many as eight such openings 22 may be provided and the same may as illustrated in the figures, be disposed in radial alignment with each other at a location on barrel 12 that is proximate to second opening 20 as shown. In an alternate embodiment best depicted in FIGS. 9 and 10, openings 22 are provided in like number to slits 32 and in axial alignment therewith.

By way of example, and not by way of limitation, openings 22 may be two millimeters in diameter. Naturally, the number and size of openings 22 may vary within the skill of the art and all such variations are embraced within the spirit and scope of the present application. Such variations include the disposition of the openings 22 in radial alignment with each other and equi distant from each other.

Referring now to FIGS. 3 and 4, cross sectional views of adapter 10 are shown, in use with a writing instrument lodged therein. In FIG. 3, eraser 26 is disposed in the cap receiving end 20, while the writing instrument 28 (a pencil) is shown positioned in first instrument receiving opening 18. It can also be seen in this view the manner in which the ribs 24 resiliently and releaseably engage the outer surface of pencil 28 to maintain pencil 28 in stable position within adapter 10. Likewise, adapter 10 serves as a cap and safety feature in the instance where the pencil 28 is not in use, so that in accordance with FIG. 4, pencil 28 is shown telescopically inserted within adapter 10 with the pencil point directed within barrel 12 and thereby safely removed from exposure to inadvertent injury or damage to clothing or person. In both illustrations, the disposition of ribs 24 releaseably and stably engages and holds the outer surface of the writing instrument 28 within adapter 10 so that even in storage, the user can have confidence in the secure engagement and retention of the writing instrument. In both illustrations, the eraser 26 that is representative of the member disposed on the cap receiving end 20, is shown and thereby provides an additional aid to the pencil user.

Specifically, it will be noted that instrument 28 which is intended to represent a standard wooden pencil, does not depict the presence of the conventional eraser thereon. This illustration is meant to simulate the instance where the eraser that normally accompanies the new pencil has been expended and is no longer available and therefore useful. In such instance, the benefits of the adapter are apparent, as the adapter is capable of receiving eraser refills having a configuration corresponding to that of eraser 26, so that constant availability of a fresh eraser for use by the writer when the writing instrument is properly extended and engaged, is always afforded.

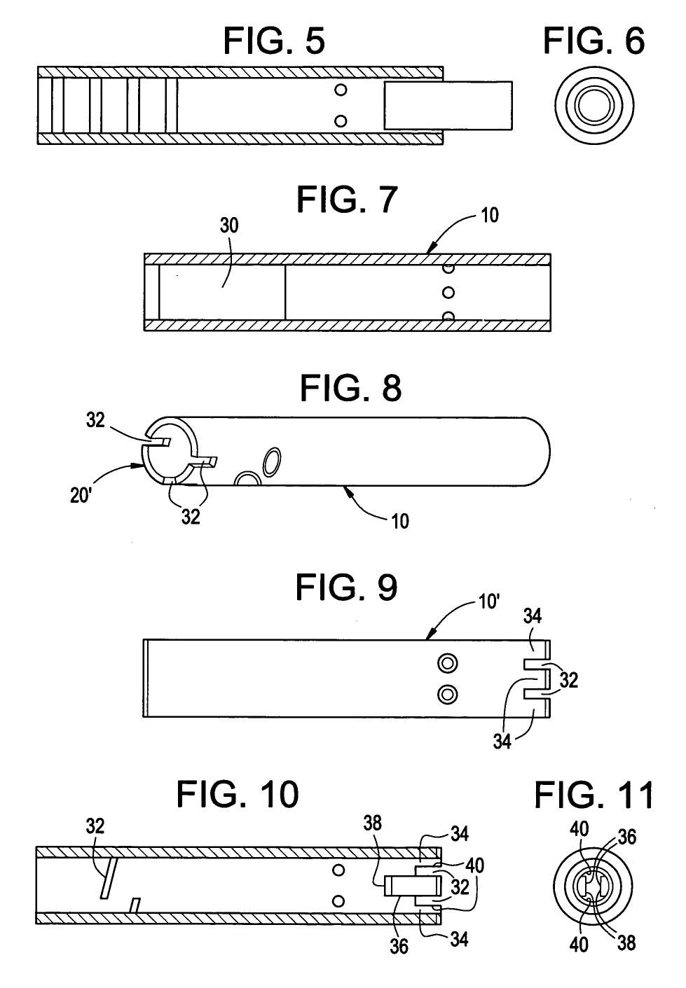

Referring now to FIGS. 5 and 6, these figures depict in dimensional detail, certain of the illustrative embodiments described earlier on herein. Thus, in FIG. 5, the entirety of adapter 10 is depicted with the ribs disposed within particular illustrative dimensions with respect to each other proximate to the writing instrument-receiving end 18, and with the ventilation means represented by openings 22, shown proximate to the cap receiving end 20, as well as the disposition of an eraser 26 therewithin. It should be understood that the dimensions depicted in FIGS. 5 and 6, and any such dimensions as disclosed, may vary within the scope of the invention. For example, the adapter may be larger or smaller in length and diameter, to accommodate corresponding variations in the size of the writing instruments with which the adapter is to be used. The invention embraces all such variations within its spirit and scope.

From the above illustrations and descriptions, the advantages of the present adapter can be readily appreciated. As described earlier, the adapter offers a versatile solution to the continued use of fixed writing instruments such as standard wooden pencils, that accommodates their reduction in length during use, while offering a safe alternative to the direct use of the pencil itself. Likewise, the ability to replace the eraser upon its expenditure, offers a benefit that is unavailable in the instance where a fixed and standard pencil is concerned. More importantly, however, the use of the adapter when the writing instrument is to be stored, confers significant benefit in the avoidance of injury to the person of the pencil user as well as damage to the person's clothing that would be caused from the inadvertent puncturing or damage to the surface of articles of clothing. Equally, significantly, the disposition of the ventilation means at the end proximate to the cap end, assists in the flow of air and possibly averts the suffocation of a user in the instance where an inadvertent placement of the writing instrument e.g. in the mouth, takes place. This is particularly true as described above, in the instance of young children who have a tendency to place writing instruments such as pencils in potentially dangerous positions on their person.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. A writing instrument adapter comprising an essentially tubular housing/barrel, said barrel having a first writing instrument-receiving opening, a second cap-defining/receiving opening and a continuous inner wall surface extending therebetween;
gripping means disposed on said inner wall surface proximate to said first opening for releaseably engaging said writing instrument,
and ventilation means located proximate said second opening, for allowing the passage of air through said writing instrument adapter, for averting suffocation of a user in the event of accidental lodgment of said adapter in the throat of a user.

2. The adapter of claim 1 wherein said gripping means comprises a continuous sleeve member projecting/extending radially inwardly from said inner wall surface.

3. The adapter of claim 1 wherein said gripping means comprises a plurality of ribs projecting/extending radially inwardly from said inner wall surface.

4. The adapter of claim 3 wherein said ribs are continuous.

5. The adapter of claim 2 wherein said gripping means comprises a single rib.

6. The adapter of claim 5 wherein said rib extends helically along said inner wall surface.

7. The adapter of claim 2 wherein said sleeve is resilient.

8. The adapter of claim 3 wherein said ribs are resilient.

9. The adapter of claim 3 wherein four of said ribs are defined.

10. The adapter of claim 1 wherein said ventilation means comprises at least two openings in said barrel.

11. The adapter of claim 10 wherein a plurality of said openings are disposed about said barrel in radial alignment with each other.

12. The adapter of claim 11 wherein said openings are spaced equidistantly from each other.

13. The adapter of claim 1 further including a closure engaging said second end.

14. The adapter of claim 13 wherein said closure is an end cap adapted to receive said second end there within.

15. The adapter of claim 13 wherein said closure is an end cap adapted to be telescopically received within said second end.

16. The adapter of claim 15 wherein said closure defines an eraser thereon.

17. The adapter of claim 15 wherein said closure defines an eraser and said eraser projects externally and away from said second end.

18. The adapter of claim 15 wherein said closure is an eraser.

19. The adapter of claim 13 wherein said second end includes biasing means for frictional engagement of said closure.

20. The adapter of claim 19 wherein said biasing means comprises a plurality of radially inwardly biased, axially extending fingers and corresponding slits disposed therebetween.

21. The adapter of claim 19 further including ventilation means comprising at least two openings in said barrel and said openings are disposed in axial alignment and corresponding number with said slits.

22. The adapter of claim 20 wherein said fingers define inwardly directed extensions to further assist in the gripping engagement of said closure.

23. The adapter of claim 1 wherein said second end further includes stop means disposed in axial displacement therefrom, to limit the extent of insertion of an end cap or eraser, and to support said closure in position.
